(19) United States
(12) Patent Application Publication
(10) Pub. No.: US 2003/0227445 A1
(43) Pub. Date: Dec. 11, 2003

(54) Easy keyboard (e-keyboard)

(76) Inventor: Xu Cong Wang, North Potomac, MD (US)

Correspondence Address: Xu Cong Wang, 14001 Saddle River Dr., North Potomac, MD, 20878, US

(21) Appl. No.: 10/165,669

(22) Filed: Jun. 8, 2002

(51) Int. Cl. G09G 5/00

(52) U.S. Cl. 345/168

(57) ABSTRACT

A design of the easy keyboard for use in conjunction with small computerized apparatus. The keyboard allows a user to touch type with multiple keys by using a natural finger movement (three-directions) capability while maintaining the traditional QWERTY key layout.

### BACKGROUND OF INVENTION

Handheld computers and other handheld electronic devices are becoming increasingly popular. These devices are held in the palm of the hand and typically run applications that store calendar and contact information, access the Internet or wireless telephone systems, or do word processing and the like. Such applications require the entry of numbers and text into the device.

Handheld electronic device typically include a small keyboard for entering numbers and text. The keyboard has miniaturized keys laid out in a standard QWERTY arrangement. Because of their small size, the keys require “hunt and peck” typing with a single finger or a stylus. In either case, touch typing impossible and data input is slow and tedious.

Some handheld devices include keyboards which eliminate keys to reduce size. Such keyboards require a “chording” system wherein two or more keys must be simultaneously pressed to generate keystrokes for the eliminated keys. Chording system also does not enable touch typing and the data input is also slow.

Thus, there is a need for an improved portable keyboard for use with handheld electronic devices. The improved keyboard should enable touch typing for the quick and efficient input of data, be compact, and should be usable without the need for additional external support during use.

### FIGURES

FIG. 1 is a top plan view of the left hand of the easy keyboard design;

FIG. 2 is a top plan view of the right hand of the easy keyboard design;

FIG. 3 is rear elevational view of the relationship of keys and a finger;

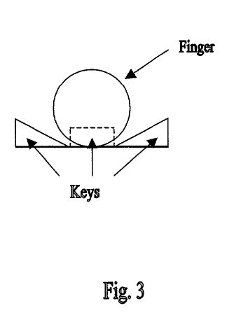

FIG. 4 is a right side elevational view of the relationship of keys and a finger, the left side elevational view being a mirror image thereof.

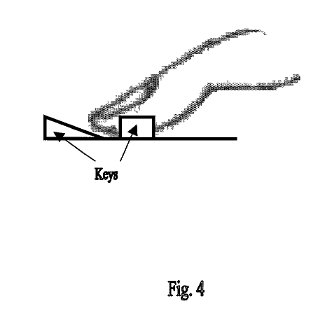

### DETAILED DESCRIPTION

The present invention is directed to an improved keyboard for use with handheld electronic devices. The improved keyboard is compact, enables touch typing for the quick and efficient input of data, and is usable without the need for additional external support during use.

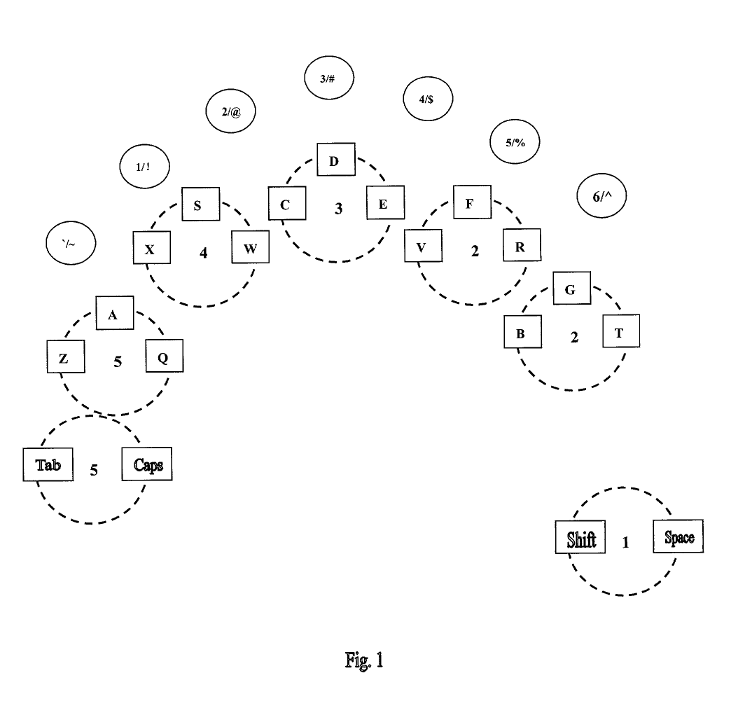

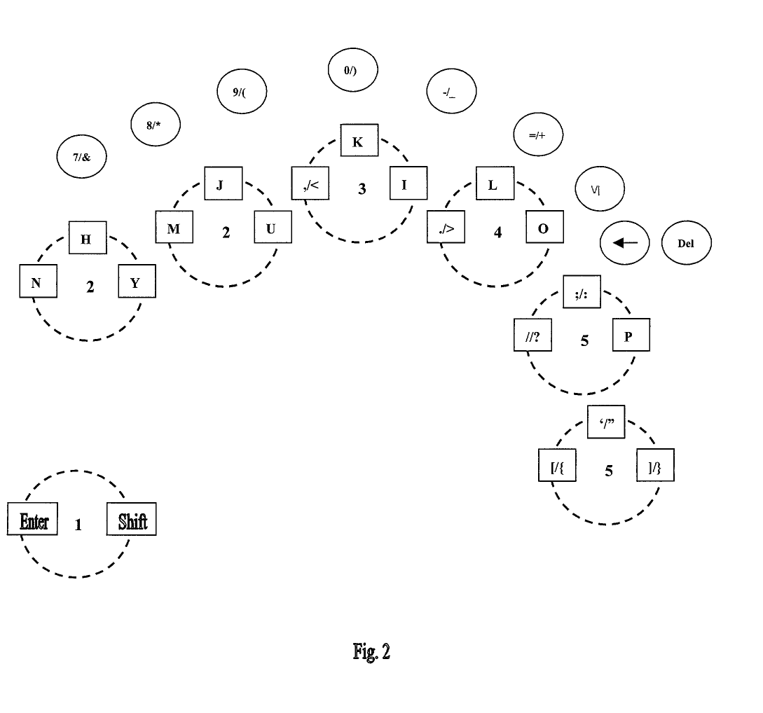

This present invention is a easy keyboard for use in small computerized apparatus as Personal Digital Assistants, small personal organizers, palm-size computers, combination phone/computers and other devices that are commonly termed “pen-based computers”. The keyboard are operated by fingers moving north, east, west around their at rest position. A keyboard user's fingers move less than one ⅙ inch in each direction. The keyboard is preferably arranged in the common QWERTY layout. The fingers position are indicated at FIG. 1 and FIG. 2.

At FIG. 1, the user's fingers positions are indicated by the cycle with dashed line. The thumb is indicated by 1; the index finger is indicated by 2; the middle finger is indicated by 3; the ring finger is indicated by 4; the little finger is indicated by 5. Each finger indicated:

The thumb is used to shift to the Shift key (west) or the Space key (east).

The index finger is used for two sets:

It shift to b/B (west), g/G (north), t/T (east), respectively;

It shift to v/V (west), f/F (north), r/R (east), respectively;

The middle finger is used to shift to c/C (west), d/D (north), e/E (east), respectively;

The ring finger is used to shift to x/X (west), s/S (north), w/W (east), respectively;

The index finger is used to two sets:

It shift to z/Z (west), a/A (north), q/Q (east), respectively;

It shift to the Tab key (west) or the Caps key (east);

At FIG. 2, the user's fingers position are same as FIG. 1. Each finger indicated:

The thumb is used to shift to the Enter key (west) or the Shift key (east);

The index finger is used to two sets:

It shift to n/N (west), h/H (north), y/Y (east), respectively;

It shift to m/M (west), j/J (north), u/U (east), respectively;

The middle finger is used to shift to ,/<(west), k/K (north), i/I (east), respectively;

The ring finger is used to shift to ./>(west), I/L (north), o/O (east), respectively;

The index finger is used to two sets:

It shift to //? (west), ;/: (north), p/P (east), respectively;

It shift to [/{(west), ‘/” (north),]/} (east), respectively;

The present invention is advantageous to users of the small computerized apparatus in that it provides them a better option for interacting with their small computerized apparatus. The use with a keyboard is more effective for most people than pen-based systems. The use of the easy keyboard instead of a stylus allows users to enter text and data more quickly and with a lower error rate.

Because the easy keyboard system design follow by the traditional QWERTY key layout rule, learn time is very less for using this type keyboard.

What is claimed is:

1. A design of easy keyboard which keyboard are operated by fingers moving north, east, west around their at rest position, use allows a user to touch typing multiple keys by using a natural finger movement (three-directions) capability while maintaining the traditional QWERTY key layout.

2. The easy keyboard of claim 1, wherein indicate keyboard user's fingers move less than one ⅙ inch in each direction as stander but the moving distance can be any size depend on variation of natural human hand size.

3. The easy keyboard of claim 1, wherein any shape of the keys depend on claim 1.

4. The easy keyboard of claim 1, wherein any color of the keys depend on claim 1.

5. The easy keyboard of claim 1, wherein any size of the keys depend on claim 1.

6. The easy keyboard of claim 1, wherein any shape of the keyboard depend on claim 1.

7. The easy keyboard of claim 1, wherein any color of the keyboard depend on claim 1.

8. The easy keyboard of claim 1, wherein any size of the keyboard depend on claim 1.

9. The easy keyboard of claim 1, wherein any deployment of the keys depend on claim 1.

10. The easy keyboard of claim 1, wherein the relation of the finger moving with the keys are in three directions.

11. The easy keyboard of claim 1, wherein allows users to enter text and data more quickly and with a lower error rate compare with a “pen-based” input method.

12. The easy keyboard of claim 1, wherein is not only used for handheld computers and other handheld electronic devices, it can also be on a desktop or in a keyboard tray mounted to the underside of a desk.

13. The easy keyboard of claim 1, wherein is not need any additional external support during easy keyboard using.
